(19) United States
(12) Patent Application Publication
(10) Pub. No.: US 2004/0012568 A1
(43) Pub. Date: Jan. 22, 2004

(54) Flat mouse

(76) Inventors: Ivan Valkov Velikov, Burnaby (CA); Antoaneta Emilianova Eneva, Burnaby (CA)

Correspondence Address: Ivan Velikov, P.O. Box 48, Kustendil, 2500, BG

(21) Appl. No.: 10/406,088

(22) Filed: Apr. 4, 2003

Related U.S. Application Data
(60) Provisional application No. 60/397,214, filed on Jul. 22, 2002.

(51) Int. Cl. G09G 5/08

(52) U.S. Cl. 345/163

(57) ABSTRACT

A flat mouse for a portable computer comprises an upper flat plate, sliding over a lower fixed tracking device. The flat plate contains the buttons of the mouse. The fixed tracking device detects the movement of the flat plate. In a preferred embodiment the mouse is integrated within the base of a portable computer in the palm-rest area. In another embodiment the mouse is detachable and can be plugged to any computer and put on any surface without a mouse pad.

### CROSS-REFERENCE TO RELATED APPLICATIONS

This application claims benefit under 35 U.S.C. .sctn. 119(e) of U.S. Provisional application No. 60/397,214 filed on Jul. 22, 2002, entitled “Flat Mouse”, naming Ivan Valkov Velikov and Antoaneta Emilianova Eneva as the inventors.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates generally to input devices for computer systems, and more particularly, to a manually controlled pointing device for a portable computer, such as a flat mouse.

Portable computers are smaller than the other computers and therefore are suitable for everyday hand-carrying. Portable computers are designed to be as small as possible at the time of their design. Portable computers typically include a base and a cover. The cover of the portable computer is attached by a hinge or hinges to the base and incorporates the screen. The base usually incorporates the typical for any computer parts such as a motherboard, a microprocessor, a video controller, a memory, a hard and floppy disc drives, a CD and DVD drives, a keyboard, plugs for external devices and a pointing device. The keyboard often occupies half of the upper surface of the base of the portable computer. The other half, usually called palm-rest area is used for mounting a pointing device and for a surface to place the hands of the operator during typing.

A pointing device is an input device used to generate input signals to the computer. The pointing device detects a movement of a hand or finger of the operator or pressing of a button. The signals generated by the pointing device result in a movement of the cursor or in executing of a command by the computer.

Some of the most spread pointing devices for controlling the cursor movement on the screen of a portable computer are a touchpad or a trackpad, a trackball and a conventional mouse. The use of a conventional mouse attached by a cable to a portable computer instead or together with the built-in touchpad gives to the operator the possibilities to benefit from the advantages of the mouse and the touchpad and to avoid their disadvantages.

The touchpads are preferred to the trackballs for integration within the portable computers because they are flat. One type of touchpad uses field-distortion technology. Different layers of electrodes are arranged under the touchpad's surface. The user slides a finger on the touchpad's surface and distorts the electrical field created by the electrodes which results in a movement of the cursor on the screen. To select an item on the screen, the user taps the touchpad or presses a button, if present.

A mouse usually comprises a body to be hold by hand, a tracking device to detect the movement of the body, one or more buttons to generate specific signals, a cable or a transmitter to transmit the signals to the computer. The mouse is usually placed beside the keyboard. The mouse typically requires a horizontal surface on which to move. For ergonomic purpose, when it is in operable configuration, a mouse is usually big enough to be hold by the whole hand of the user. The main advantage of the mouse is that its buttons move together with the fingertips of the operator.

Regarding the use with a portable computer, a touchpad possesses the following disadvantages compared with a conventional mouse:

a touchpad does not react on the movements of the whole hand of the operator, but only on the movements of the fingertips, thus causing stress in the fingers;

the touchpad's buttons do not move together with the fingertips, thus constantly require either relocation of the fingers from the touchpad to the buttons and back, or the use of two hands;

in case of using double tapping for clicking, the touchpad does not have more than one virtual button; and

using a touchpad, an operator has to relocate the operable finger from the touchpad to the side of it in order to relax between two operations.

Regarding the use with a portable computer, a conventional mouse possesses the following disadvantages compared with a touchpad:

a mouse is usually not integrated within the base of a portable computer, therefore it requires a place to be stored;

a mouse may require a horizontally placed mouse pad, otherwise it may not be able to move or if the pad is not horizontal it may move by itself;

a mouse may require a cable to be connected to the computer and a repeating act of connecting and disconnecting of the cable;

a mouse has to be hold by the thumb and the other fingers which causes stress in the whole arm;

a mouse is usually placed at such distance from the keyboard, that the operator has to move a hand from the shoulder to hold the mouse after typing on the keyboard; and

the use of a conventional mouse makes the touchpad useless.

Therefore, what is needed to overcome the disadvantages of the touchpad and the conventional mouse is a pointing device suitable for use with a portable computer:

which is flat;

which may be integrated within the base of a portable computer, close to the keyboard;

which reacts on the movements of the whole hand of the operator;

which includes buttons movable together with the fingertips;

which has not to be hold by the thumb and the other fingers of the operator;

which does not necessarily require a mouse pad and a cable;

which provides a place for the hand and for all the fingers to relax in operable position; and

which does not move by itself when the base of the portable computer is not horizontal.

### BRIEF SUMMARY OF THE INVENTION

According to the invention, a flat computer mouse comprises an upper flat plate, sliding over a lower fixed tracking device. The flat plate contains the buttons of the mouse. The fixed tracking device determines the position or the direction and magnitude of movement of the flat plate and generates input signals to the computer. The buttons generate input signals to the computer.

According to one aspect of the invention, the user operates the flat mouse by putting fingers over the flat plate without holding it and applying slight horizontal force to it. The hand relaxes over the flat plate. The fingers which push the buttons are placed over the buttons and the other fingers are placed over the rest of the flat plate.

According to another aspect of the invention, in a preferred embodiment the flat mouse is integrated within the base of a portable computer. In this embodiment the flat mouse comprises a body, a flat plate, a fixed tracking device and buttons. The tracking device and the buttons are electrically coupled to the computer.

According to another aspect of the invention, in another embodiment the flat mouse is detachable and can be plugged to any computer and put on any surface without a mouse pad. In this embodiment the flat mouse comprises a body, a flat plate, a fixed tracking device, buttons and a communication interface to transmit the signals to the computer. In one embodiment the communication interface includes a cable for electrically connecting the tracking device and the buttons to the computer. In another embodiment the communication interface includes signal transmission means for transmitting the input signals through a wireless media.

According to another aspect of the invention, the flat plate is attached to the body of the flat mouse. In one embodiment the flat plate has a deep lateral channel. The upper surface of the body of the flat mouse has a rectangular-shaped opening. The edges of the opening are inserted into the deep lateral channel of the flat plate and constrain the horizontal movement of the flat plate. In another embodiment the flat plate is attached to the body of the flat mouse through magnetic connection. The body of the flat mouse incorporates magnets which attract the flat plate and constrain the movement thereof.

According to another aspect of the invention, the flat mouse includes one or more flat push-buttons mounted on the flat plate which generate specific signals such as “click” and “right-click”, and a flat slide-button mounted on the flat plate which generates a “scroll” signal. The buttons are movable together with the flat plate.

According to the advantages of the invention, in one preferred embodiment, the flat mouse is integrated within a base of a portable computer; it is thin; it reacts on the movements of the whole hand of the operator; its buttons move together with the fingertips; it has not to be hold by the user; it is very close to the keyboard; it does not need a mouse pad and a cable; it provides a place for the hand of the operator to relax in operable position; it does not move by itself when the base of the portable computer is not horizontal. In another embodiment the flat mouse is detachable and can be plugged to any computer and put on any surface without a mouse pad. These and other advantages of the invention will be better understood by reference to the following detailed description and the accompanying drawings.

### BRIEF DESCRIPTION OF THE SEVERAL VIEWS OF THE DRAWING

FIG. 1 is a diagram of a pointing device connected to a computer through a communication interface;

FIG. 2 is a diagram of a pointing device integrated within the body of a computer;

FIG. 3 is an axonometric view illustrating a portable computer having a flat mouse in various embodiments;

FIG. 4 is a perspective view illustrating the way of placing of a user's hand over a flat mouse;

FIG. 5 is an exploded axonometric view of a preferred embodiment of a flat mouse integrated within the base of a portable computer;

FIG. 6 is a sectional view 1-1 of the flat mouse of FIG. 5;

FIG. 7 is an exploded axonometric view of an embodiment of a detachable flat mouse;

FIG. 8 is a sectional view 2-2 of the flat mouse of FIG. 7;

FIG. 9 is an exploded axonometric view of another embodiment of a flat mouse;

FIG. 10 is a sectional view 3-3 of the flat mouse of FIG. 9.

### DETAILED DESCRIPTION OF THE INVENTION

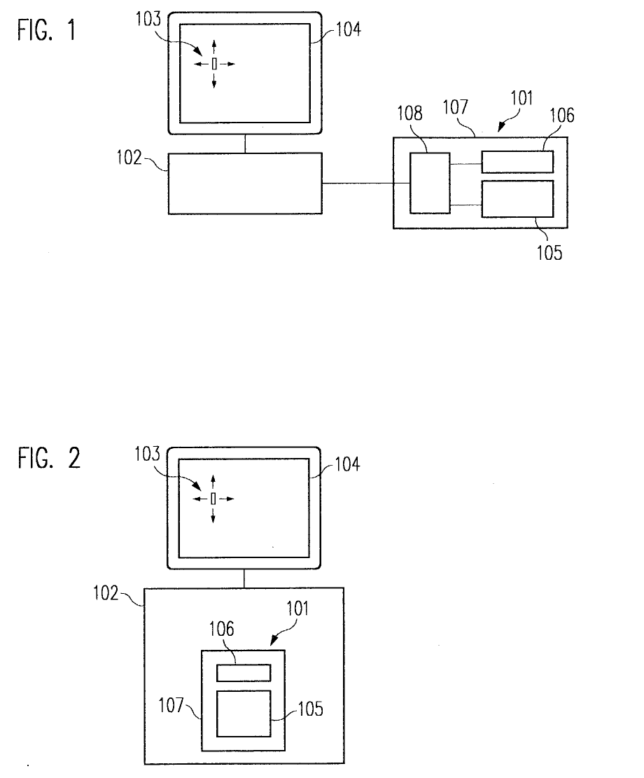

Referring to FIG. 1, a computer pointing device 101 is used with a computer 102 to control the movement of a cursor 103 on a computer screen 104. The pointing device 101 includes a tracking device 105, one or more buttons 106, a body 107 and a communication interface 108. The tracking device 105 detects a movement of the whole pointing device relative to the surface on which it is placed and generates input signals to the computer. Signals generated by the tracking device 105 and the buttons 106 are sent to the computer 102 through the communication interface 108. The communication interface 108 may include a cable for electrically connecting the pointing device to the computer or signal transmission means for transmitting the signals through a wireless media.

Referring to FIG. 2, a computer pointing device 101 is used with a computer 102 to control the movement of a cursor 103 on a computer screen 104. The pointing device 101 includes a tracking device 105, one or more buttons 106 and a body 107. The pointing device 101 is integrated within the body of the computer 102. The tracking device 105 detects a movement of a user's fingertip and generates input signals to the computer. The tracking device and the buttons are electrically coupled to the computer.

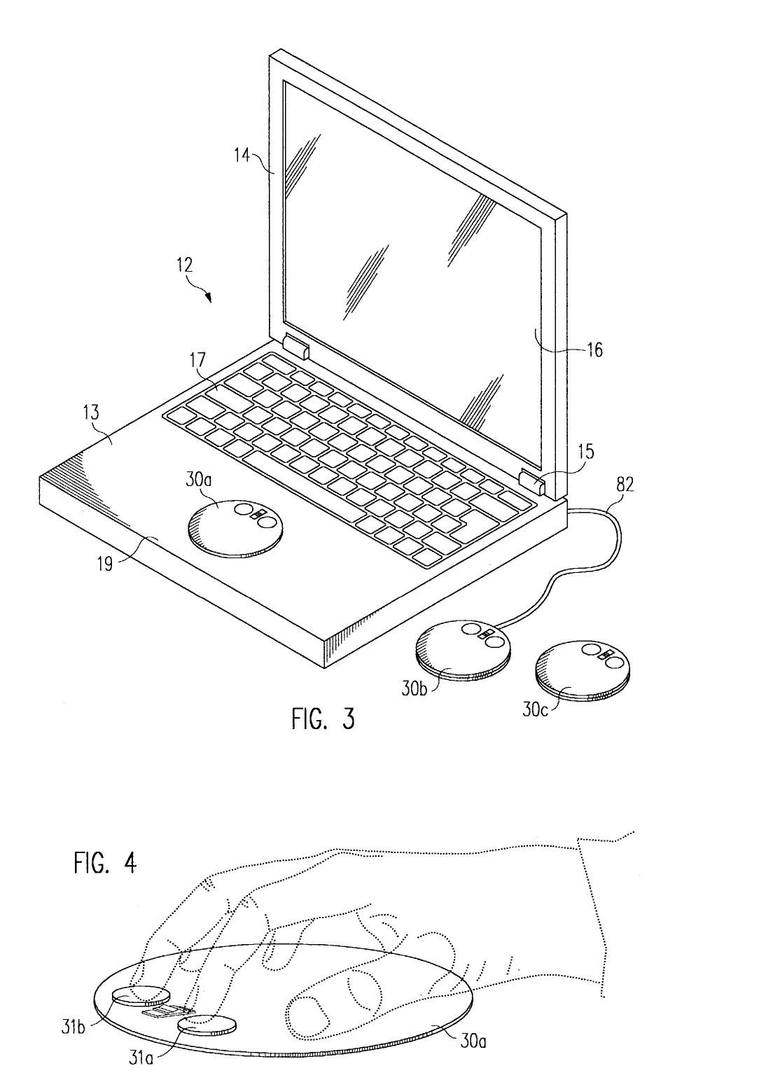

Referring to FIG. 3, illustrated is a portable computer 12 including a base 13 and a cover 14. The cover is attached by hinges 15 to the base and incorporates the flat computer screen 16. A keyboard 17 is mounted on the base. In one embodiment a pointing device—flat mouse 30a is mounted on the base 13 in the palm-rest area 19. In another embodiment a detachable flat mouse designated 30b is connected to the computer by a cable 82. In yet another embodiment a detachable flat mouse designated 30c is connected to the computer through a wireless media.

Referring to FIG. 4, illustrated is the way of placing of user's hand over a flat mouse 30a. The fingers which push the buttons are placed over the buttons 31a and 31b and the other fingers are placed over the rest of the flat mouse.

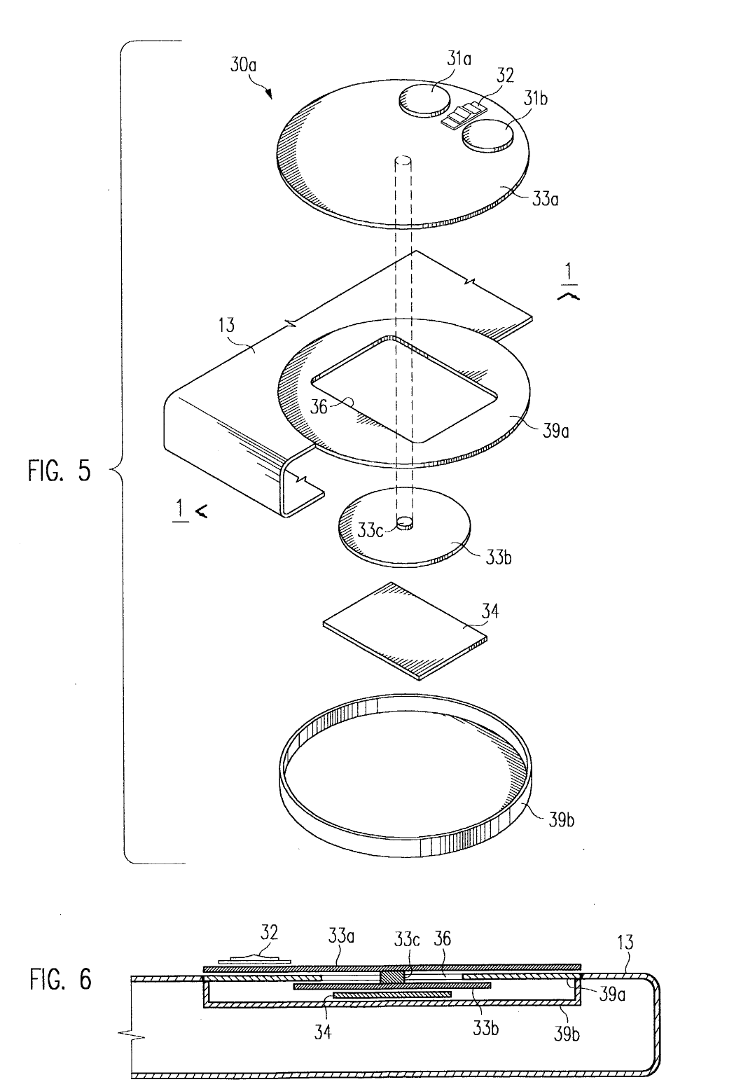

Referring to FIGS. 3, 5 and 6, illustrated is a preferred embodiment of the flat mouse 30a. The flat mouse 30a is mounted within the base 13 of the portable computer 12. In this embodiment the flat mouse comprises a flat plate, a body, push-buttons, a slide-button and a fixed tracking device. The flat plate comprises an upper part 33a, a lower part 33b and a middle part 33c. The upper part 33a and the lower part 33b are connected by the middle part 33c, thus forming one flat plate having a deep lateral channel between the upper part and the lower part. The body comprises an upper member 39a and a lower member 39b. The upper member has a rectangular-shaped opening 36. The edges of the opening are inserted into the deep lateral channel of the flat plate to constrain the horizontal movement of the flat plate. The upper member 39a and the lower member 39b of the body are integrated within the base 13 of the portable computer. The tracking device 34 is mounted on the lower member of the body 39b. The tracking device 34 determines the position or the direction and magnitude of movement of the flat plate and generates input signals to the computer. The push-buttons 31a and 31b and the slide-button 32 are mounted on the upper part 33a of the flat plate. The buttons generate input signals to the computer. The tracking device and the buttons are electrically coupled to the computer.

In a preferred embodiment the tracking device includes an electronic system which determines the magnitude of movement of the flat plate in two perpendicular directions. In this embodiment the electronic system comprises a flat rectangular-shaped resistor and two sensors connected to the two perpendicular edges of the resistor—left edge and front edge. A definite point on the lower surface of the flat plate of the mouse is connected to the sensors. The point slides on the surface of the flat resistor as the flat plate is moved. The electronic system measures the change of electrical resistance between the point and the two perpendicular edges of the resistor and generates movement signals to the computer.

Although a specific electronic embodiment is described, other mechanical or optical based tracking devices may also be used.

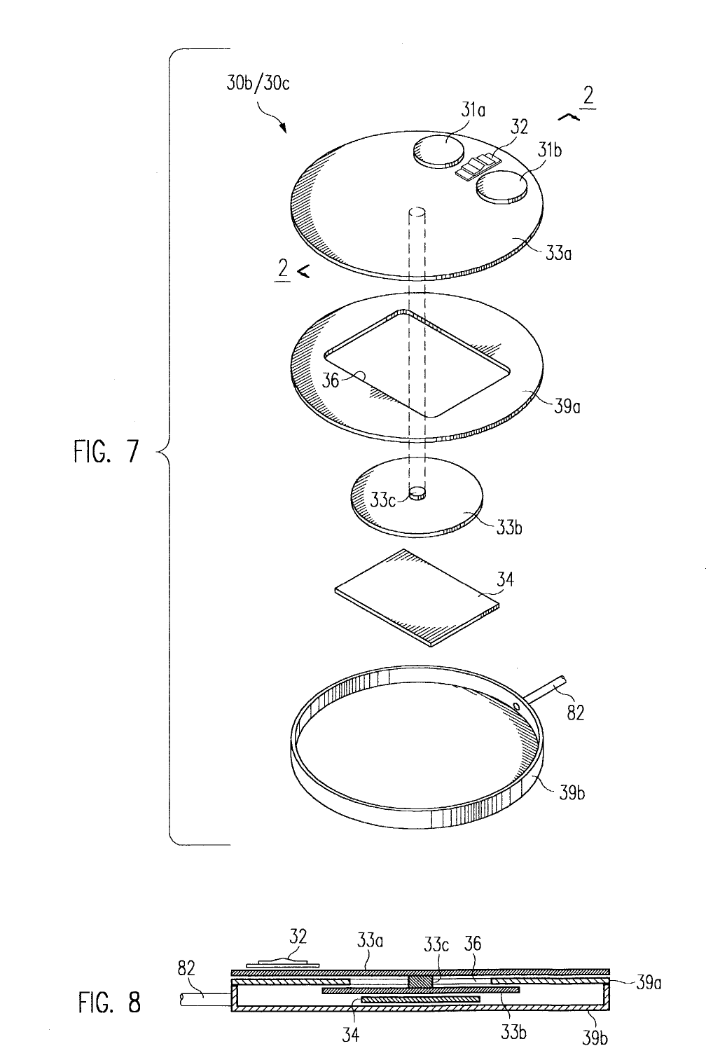

Referring to FIGS. 7 and 8, illustrated is one embodiment of the detachable flat mouse 30b and 30c of FIG. 3. In this embodiment the flat mouse comprises a flat plate, a body, push-buttons, a slide-button, a fixed tracking device and a communication interface. The flat plate comprises an upper part 33a, a lower part 33b and a middle part 33c. The upper part 33a and the lower part 33b are connected by the middle part 33c, thus forming one flat plate having a deep lateral channel between the upper part and the lower part. The body comprises an upper member 39a and a lower member 39b. The upper member has a rectangular-shaped opening 36. The edges of the opening are inserted into the deep lateral channel of the flat plate to constrain the horizontal movement of the flat plate. The tracking device 34 is mounted on the lower member of the body 39b. The tracking device 34 determines the position or the direction and magnitude of movement of the flat plate and generates input signals to the computer. The push-buttons 31a and 31b and the slide-button 32 are mounted on the upper part 33a of the flat plate. The buttons generate input signals to the computer.

For the embodiment of the detachable flat mouse 30b, the communication interface includes a cable 82 electrically coupled to the mouse and to the computer, the cable transmitting the signals from the tracking device and the buttons to the computer. For the embodiment of the detachable flat mouse 30c, the communication interface includes signal transmission means for transmitting the movement signals from the tracking device and the buttons to the computer through a wireless media.

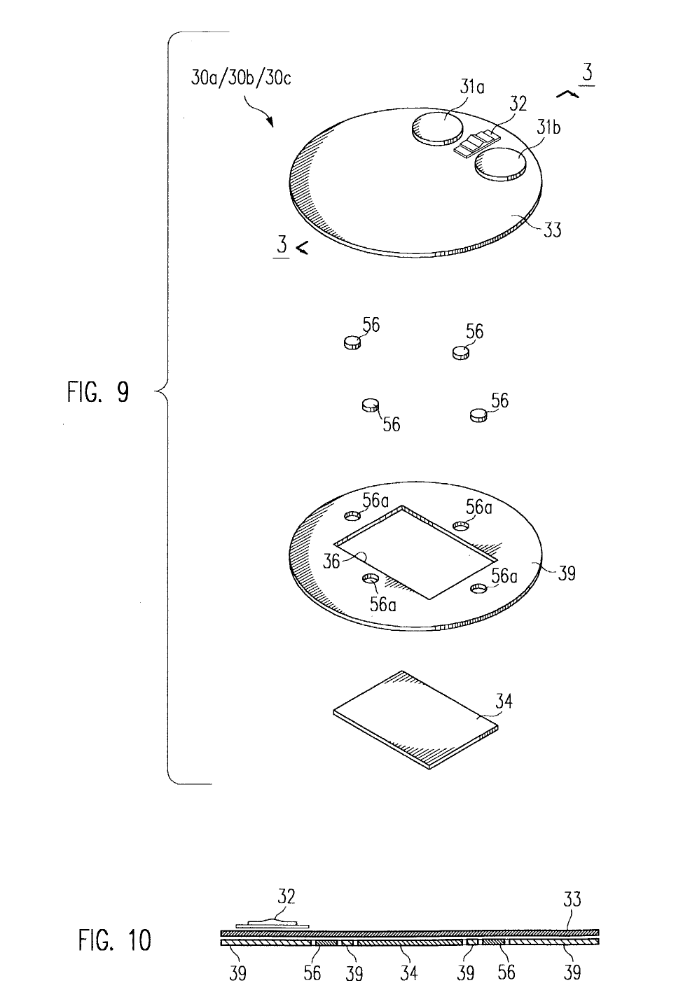

Referring to FIGS. 9 and 10, illustrated is another embodiment of the body and the flat plate of the flat mouse 30a, 30b and 30c of FIG. 3. In this embodiment the flat plate 33 is made of material which can be attracted by magnets. The body 39 has holes 56a within which are mounted magnets 56. The magnets attract the flat plate 33 to attach it to the body 39. The tracking device 34 is mounted within the opening 36 of the body 39. The push-buttons 31a and 31b and the slide-button 32 are mounted on the flat plate 33.

Meritorious and Advantageous Effects

According to the advantages of the invention, in one preferred embodiment, the flat mouse is integrated within a base of a portable computer; it is thin; it reacts on the movements of the whole hand of the operator; its buttons move together with the fingertips; it has not to be hold by the user; it is very close to the keyboard; it does not need a mouse pad and a cable; it provides a place for the hand of the operator to relax in operable position; it does not move by itself when the base of the portable computer is not horizontal. In another embodiment the flat mouse is detachable and can be plugged to any computer and put on any surface without a mouse pad.

Although a preferred embodiment of the invention has been described and illustrated, various alternatives, modifications and equivalents may be used. Therefore, the foregoing description should not be taken as limiting the scope of the invention which is defined by the appended claims.

We claim:

1. A pointing apparatus controlling movement of a cursor on a screen of a computer, comprising:
an upper flat plate movable in a horizontal direction;
a lower fixed tracking device which generates movement signals based on the movement of the flat plate relative to the tracking device, the movement signals for controlling the movement of the cursor on the screen of the computer;
a push-button which generates input signals to the computer, the push-button being mounted on the flat plate; and
a slide-button which generates input signals to the computer, the slide-button being mounted on the flat plate.

2. The pointing apparatus of claim 1, in which the flat plate comprises:
a lower part;
a middle part; and
un upper part, the three parts being joined one over another forming one flat plate having a deep lateral channel between the upper part and the lower part.

3. The pointing apparatus of claim 2, further comprising:
a body within which the tracking device and the flat plate are housed, the body having a lower member and an upper member, the lower member having mounted the tracking device thereon, the upper member having a rectangular-shaped opening, the edges of the opening being inserted into the deep lateral channel of the flat plate to constrain the horizontal movement of the flat plate.

4. The pointing apparatus of claim 1, in which the flat plate is made of material which can be attracted by magnets.

5. The pointing apparatus of claim 4, further comprising:
a body within which the tracking device and the flat plate are housed, the body having mounted the tracking device and magnets thereon, the magnets attracting the flat plate to attach it to the body.

6. The pointing apparatus of claim 1, further comprising:
connection means for electrically connecting the tracking device and the buttons to the computer.

7. The pointing apparatus of claim 1, further comprising:
signal transmission means for transmitting the movement signals from the tracking device and the buttons to the computer through a wireless media.

8. The pointing apparatus of claim 1, mounted in a base of a portable computer.
